(19) United States
(12) Patent Application Publication
(10) Pub. No.: US 2006/0099424 A1
(43) Pub. Date: May 11, 2006

(54) Multilayer injection compression molding method using recycled material, and molded product molded through the same

(75) Inventors: Isao Hagiwara, Yokohama-shi (JP); Hirohide Matsuhisa, Yokohama-shi (JP); Shinichi Miyauchi, Kawasaki-shi (JP); Sumire Kubota, Kawasaki-shi (JP); Daishi Saiki, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/258,898

(22) Filed: Oct. 27, 2005

(30) Foreign Application Priority Data
Nov. 10, 2004 (JP) 2004-326588

(51) Int. Cl. B29C 45/16; B32B 27/36; B32B 27/32; B32B 27/30

(52) U.S. Cl. 428/411.1; 264/255; 428/523; 428/412; 428/521; 428/522

(57) ABSTRACT

There is provided a multilayer molding method using an unused thermoplastic resin material and a recycled thermoplastic resin material, including molding at least one layer through an injection compression molding method. The multilayer molding method allows improvement in use rate of the recycled thermoplastic resin material with favorable appearance and sufficient mechanical strength maintained in reuse of the recycled thermoplastic resin into a product.

### BACKGROUND OF THE INVENTION

1. Field of the Invention

The present invention relates to a molding method for reusing a recycled thermoplastic resin into a product, and to a molded product molded through the same.

In particular, the present invention relates to a multilayer molding method using an unused thermoplastic resin material and a recycled thermoplastic resin material, including molding at least one layer formed of one of the unused thermoplastic resin material and the recycled thermoplastic resin material through an injection compression molding method, and to a molded product molded through the same.

Further, the present invention relates to a technique of subjecting a molded product of a thermoplastic resin to pulverization treatment, and using the pulverized resin material as it is as a resin raw material for injection compression molding.

Further, the present invention relates to a technique of recycling a plastic resin material used for image forming apparatuses such as a copying machine and a printer, information and communication devices such as a facsimile and a computer, household appliances, and the like.

2. Related Art

Products collected from markets are hitherto disassembled and then incinerated or disposed at landfills.

In consideration of environmental problems, those plastic parts are recycled by a technique of recycling the plastic parts into a material comparable to an unused resin material through pulverizing and repelletizing. That is, there is proposed a method of recycling those materials involving: pulverizing, washing, and repelletizing a molded product; and mixing an unused resin material and the above-mentioned used resin material at a specific ratio to recover physical properties for use. Further, there is proposed a recycling method using a multilayer structure represented by an injection molding method of a sandwich structure involving injection of two kinds of resin materials into a cavity of a mold. The sandwich structure includes: a resin molded part forming a core layer; and a resin molded part forming a skin layer. Further examples of the technique of using a recycled thermoplastic resin include Japanese Patent Application Laid-Open No. 2002-86491, Japanese Patent Application Laid-Open No. H05-301222, Japanese Patent Application Laid-Open No. H05-147036, and Japanese Patent No. 3031357.

However, a use rate of a recycled thermoplastic resin recycled through those recycling methods is actually low at about 30%, and a large amount of the recycled thermoplastic resin cannot be used for one molded product. Meanwhile, a molded product of 100% recycled thermoplastic resin provides insufficient appearance and mechanical strength for parts such as external parts, housing parts, and mechanism elements of image forming apparatuses and information and communication devices (such as a copying machine, a printer, and a facsimile).

An object of the present invention is to provide a molding method for improving appearance of a part molded by using a recycled thermoplastic resin, and a molded product molded through the same.

Another object of the present invention is to provide a molding method for improving mechanical strength of a part molded by using a recycled thermoplastic resin, and a molded product molded through the same.

Still another object of the present invention is to provide a molding method for reducing thickness of a part molded by using a recycled thermoplastic resin, and a molded product molded through the same.

Yet another object of the present invention is: to avoid deterioration in physical properties of a resin material to be reused due to heat history by using a pulverized material prepared by subjecting a resin molded product to be reused to pulverization treatment: and to improve appearance, mechanical strength, and thickness of a part molded by using the pulverized material.

The molded products each have a sheet structure of parts such as external parts, housing parts, and mechanism elements of image forming apparatuses and information and communication devices (such as a copying machine, a printer, and a facsimile).

Such a housing part must have ensured appearance and mechanical strength, but use of a 100% recycled material hardly provides ensured functions of the functional parts due to deterioration in physical properties of the recycled material.

### SUMMARY OF THE INVENTION

The present invention has been made in view of attaining the above-mentioned objects, and there is proposed a multilayer molding method using an unused thermoplastic resin material and a recycled thermoplastic resin material, characterized by including molding at least one layer through an injection compression molding method.

According to a first aspect of the present invention, a multilayer molding method using an unused thermoplastic resin material and a recycled thermoplastic resin material includes molding at least one layer through an injection compression molding method. The multilayer molding method involves injection compression molding of a surface layer formed of an unused thermoplastic resin material, to thereby supply a molded product with better appearance than that of a molded material having a surface layer of a recycled thermoplastic resin material. An unused thermoplastic resin material layer is molded into a thin layer, to thereby improve a use rate of the recycled thermoplastic resin material. Further, there is proposed a molding method capable of enhancing mechanical strength by forming an unused thermoplastic resin material layer on a recycled thermoplastic resin material, and a molded product molded through the same.

According to a second aspect of the present invention, a multilayer molding method using an unused thermoplastic resin material and a pulverized and not-repelletized resin material prepared by pulverizing a molded product of a thermoplastic resin, includes molding at least one layer through an injection compression molding method. There is proposed: a multilayer molding method capable of avoiding deterioration in physical properties of a resin material to be reused due to heat history by using the pulverized and not-repelletized material prepared by subjecting a resin molded product to be reused to pulverization treatment and capable of improving mechanical strength; and a molded product molded through the same.

According to a third aspect of the present invention, a molding method includes molding at least one layer of a multilayer molded product of an unused thermoplastic resin material, a recycled thermoplastic resin material, and a pulverized and not-repelletized resin material prepared by pulverizing a molded product of a thermoplastic resin having identical compositions through an injection compression molding method. In this way, deterioration of the recycled thermoplastic resin causes increase in fluidity and improvement in moldability, to thereby allow reduction in thickness of a layer formed of the recycled thermoplastic resin and supply of a molded product with a smaller thickness. Further, there is proposed a molding method which facilitates processing for subsequent recycle use of a molded product molded by using materials with identical compositions; and a molded product molded through the same.

There is proposed improvement in strength of a resin molded product having a multilayer structure, characterized in that the thermoplastic resin material is a polycarbonate and acrylonitrile-butadiene-stylene resin material.

There is proposed improvement in strength of a resin molded product having a multilayer structure, characterized in that the thermoplastic resin material is a polypropylene resin material.

The resin molded product is used for a part such as an external part, a housing part, or a structural part of an office machine, an electrical device, an information and communication device, or the like.

A raw material of a resin material forming another layer is a resin material obtained by subjecting to pulverization treatment a resin molded product of a part such as an external part, a housing part, or a structural part of an office machine.

Further, an injection compression molded part has a thickness of 0.1 to 0.6 mm. Such a thickness provides best effects on color difference, sink mark, and the like and allows supply of a molded product with excellent appearance.

The present invention provides a multilayer molding method using an unused thermoplastic resin material and a recycled thermoplastic resin material, including molding at least one layer through an injection compression molding method. The multilayer molding method allows improvement in use rate of the recycled thermoplastic resin material with favorable appearance and sufficient mechanical strength maintained.

Further, a resin molded product having a multilayer structure is obtained through a multilayer molding method using an unused thermoplastic resin material and a pulverized and not-repelletized resin material prepared by pulverizing a molded product of a thermoplastic resin, the multilayer molding method being characterized by including molding at least one layer through an injection compression molding method. The resin molded product having a multilayer structure is capable of avoiding deterioration in physical properties due to heat history, has a high use rate of the recycled thermoplastic resin material, and can increase strength of the molded product at low cost without a repelletizing step.

A molded product molded by using materials such as a recycled resin and an unused resin with identical compositions facilitates processing for subsequent recycle use.

Solutions for environmental problems are proposed by the resin molding method and the molded product formed into an external part or a housing part of an office machine, an electrical device, an information and communication device, or the like.

Other features and advantages of the present invention will be apparent from the following description taken in conjunction with the accompanying drawings.

### BRIEF DESCRIPTION OF THE DRAWINGS

FIGS. 1A, 1B, and 1C are each a diagram illustrating a molding method according to an embodiment of the present invention.

FIGS. 2A, 2B, and 2C are each a sectional view of a molded product according to an embodiment of the present invention.

### DETAILED DESCRIPTION OF THE PREFERRED EMBODIMENTS

Hereinafter, preferred embodiments of the present invention will be described by referring to figures. Evaluation methods are described below.

Charpy impact test: measurement in accordance with JIS K7111

Flammability test: test in accordance with UL94 (Tests for Flammability of Plastic Materials for Parts in Devices and Appliances)

### Embodiment 1

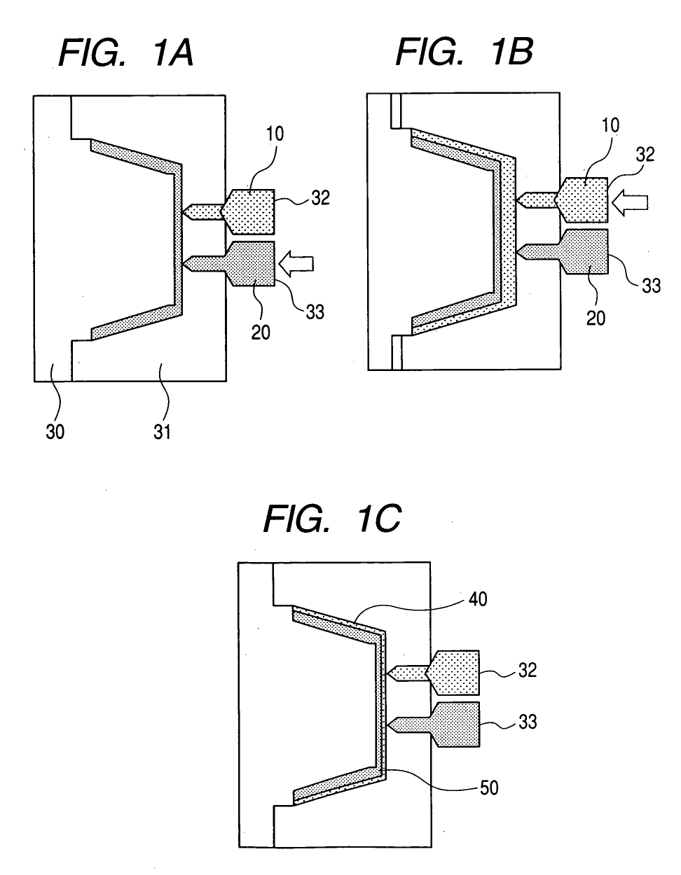

A recycled thermoplastic resin 20 is injected from an injection cylinder 33 into a mold including a movable mold 30, a stationary mold 31, and inserts thereof while the mold is closed and a mold closing force is maintained. A molten resin is cooled and solidified while a dwell pressure is applied thereto, to thereby form a first layer (FIG. 1A). Note that the first layer need not be completely solidified.

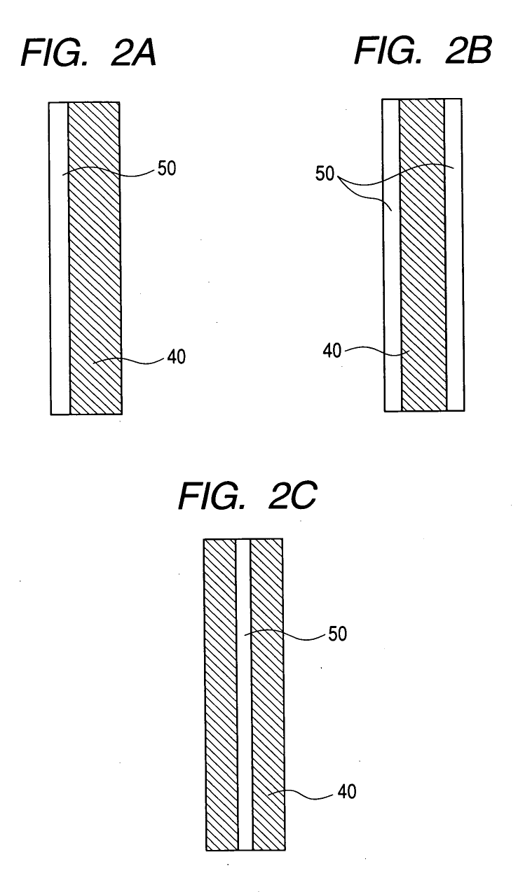

Next, the movable mold 30 is moved back for several mm and stopped, and an unused thermoplastic resin 10 is injected from an injection cylinder 32 into a newly formed space between the stationary mold and the first layer (FIG. 2B). At this time, an amount of the resin need not be equal to an amount required for completely filling the space, and a predetermined amount thereof is injected. The movable mold 30 and the stationary mold 31 each have a joint opening wider than a mold opening distance from a completely closed mold, a structure corresponding to the joint, and a function of sealing the injected resin.

Then, the movable mold 30 is moved in a direction of the stationary mold 31 for a predetermined distance before solidification of the injected molten resin during resin injection or after resin injection, to thereby compress the molten resin injected from the injection cylinder 32 (FIG. 1C). In FIG. 1C, reference numeral 50 represents a recycled thermoplastic resin layer, and reference numeral 40 represents an unused thermoplastic resin layer. The same reference numerals as those of FIG. 1C represent the same members.

Next, the molten resin is cooled and solidified to form a second layer, and a molded product is obtained from the mold.

Examples of the unused thermoplastic resin include an aromatic polycarbonate (PC) resin, a polypropylene (PP) resin, a polyphenylene ether-based resin, an olefin-based resin, a polyarylate resin, and an acrylonitrile-butadiene-styrene (ABS) resin. Further examples thereof include: the above-mentioned resins each containing a glass fiber, talc, a flame retardant, or the like; and an alloy resin containing two or more kinds of resins.

The recycled thermoplastic resin is a resin obtained by, after the thermoplastic resin is molded, subjecting the molded resin to treatment for reusing the molded resin through some kind of method. A pulverized and not-repelletized resin material prepared by pulverizing a molded product may be preferably used as the recycled thermoplastic resin.

FIG. 2A shows a sectional view of the thus-molded molded product.

### Embodiment 2

An unused thermoplastic resin 10 is injected from the injection cylinder 32 into a space between the movable mold 30 and the stationary mold 31 by using the same mold as that of Embodiment 1 with the mold opened by several mm. At this time, an amount of the resin need not be equal to an amount required for completely filling the space, and a predetermined amount thereof was injected. The movable mold 30 and the stationary mold 31 each have a joint opening wider than a mold opening distance from a completely closed mold, a structure corresponding to the joint, and a function of sealing the injected resin.

Then, the movable mold 30 is moved in a direction of the stationary mold 31 for a predetermined distance before solidification of the injected molten resin during injection or after injection, to thereby compress the molten resin injected from the injection cylinder 32.

Next, the molten resin is cooled and solidified to form a first layer.

Next, the movable mold 30 is moved back for several mm and stopped, and the recycled thermoplastic resin 20 is injected from an injection cylinder 33 into a newly formed space between the stationary mold 31 and the first layer. At this time, an amount of the resin need not be equal to an amount required for completely filling the space, and a predetermined amount thereof is injected. The movable mold 30 and the stationary mold 31 each have a joint opening wider than a mold opening distance from a completely closed mold, a structure corresponding to the joint, and a function of sealing the injected resin.

Then, the movable mold 30 is moved in a direction of the stationary mold 31 for a predetermined distance before solidification of the injected molten resin during injection or after injection, to thereby compress the molten resin injected from the injection cylinder 33.

Next, the molten resin is cooled and solidified to form a second layer.

Next, the movable mold 30 is moved back for several mm and stopped, and an unused thermoplastic resin 10 is injected from the injection cylinder 32 into a newly formed space between the stationary mold and the second layer. At this time, an amount of the resin need not be equal to an amount required for completely filling the space, and a predetermined amount thereof is injected. The movable mold 30 and the stationary mold 31 each have a joint opening wider than a mold opening distance from a completely closed mold, a structure corresponding to the joint, and a function of sealing the injected resin.

Then, the movable mold 30 is moved in a direction of the stationary mold 31 for a predetermined distance before solidification of the injected molten resin during injection or after injection, to thereby compress the molten resin injected from the injection cylinder 32.

Next, the molten resin is cooled and solidified to form a third layer, and a molded product is obtained from the mold.

The unused thermoplastic resin and recycled thermoplastic resin described above are the same as the resins described in Embodiment 1.

FIG. 2B shows a sectional view of the thus-molded molded product.

### Embodiment 3

A recycled thermoplastic resin 20 is injected from the injection cylinder 33 into the same mold as that of Embodiment 1 while the mold is closed and a mold closing force is maintained. A molten resin is cooled and solidified while a dwell pressure is applied thereto, to thereby form a first layer. Note that the first layer need not be completely solidified.

Next, the movable mold 30 is moved back for several mm and stopped, and an unused thermoplastic resin 10 is injected from the injection cylinder 32 into a newly formed space between the stationary mold 31 and the first layer. At this time, an amount of the resin need not be equal to an amount required for completely filling the space, and a predetermined amount thereof is injected. The movable mold 30 and the stationary mold 31 each have a joint opening wider than a mold opening distance from a completely closed mold, a structure corresponding to the joint, and a function of sealing the injected resin.

Then, the movable mold 30 is moved in a direction of the stationary mold 31 for a predetermined distance before solidification of the injected molten resin during injection or after injection, to thereby compress the molten resin injected from the injection cylinder 32.

Next, the molten resin is cooled and solidified to form a second layer.

Next, the movable mold 30 is moved back for several mm and stopped, and the recycled thermoplastic resin 20 is injected from the injection cylinder 33 into a newly formed space between the stationary mold 31 and the second layer. At this time, an amount of the resin need is equal to an amount required for completely filling the space. A molten resin is cooled and solidified while a dwell pressure is applied thereto, to thereby form a third layer. Then, a molded product is obtained from the mold.

The unused thermoplastic resin and recycled thermoplastic resin described above are the same as the resins described in Embodiment 1.

FIG. 2C shows a sectional view of the thus-molded molded product.

According to the embodiments of the present invention, a multilayer molding method using an unused thermoplastic resin material and a recycled thermoplastic resin material, including molding at least one layer through an injection compression molding method allows improvement in use rate of the recycled thermoplastic resin material with favorable appearance and sufficient mechanical strength maintained.

This application claims priority from Japanese Patent Application No. 2004-326588 filed on Nov. 10, 2004, which is hereby incorporated by reference herein.

What is claimed is:

1. A multilayer molding method using an unused thermoplastic resin material and a recycled thermoplastic resin material, comprising molding at least one layer formed of one of the unused thermoplastic resin material and the recycled thermoplastic resin material through an injection compression molding method.

2. A multilayer molding method using an unused thermoplastic resin material and a pulverized and not-repelletized resin material prepared by pulverizing a molded product of a thermoplastic resin, comprising molding at least one layer formed of one of the unused thermoplastic resin material and the pulverized and not-repelletized resin material prepared by pulverizing a molded product through an injection compression molding method.

3. A double layer molding method using a recycled thermoplastic resin, comprising:
molding one layer formed of an unused thermoplastic resin material through an injection compression molding method; and
molding another layer formed of the recycled thermoplastic resin material.

4. A double layer molding method using a recycled thermoplastic resin, comprising:
molding one layer formed of an unused thermoplastic resin material through an injection compression molding method; and
molding another layer formed of a pulverized and not-repelletized resin material prepared by pulverizing a molded product.

5. A molded product, which is molded through the molding method according to any one of claims 1 to 4.

6. The molded product according to claim 5, wherein a layer formed through the injection compression molding method has a thickness of 0.1 to 0.6 mm.

7. The molded product according to claim 5, wherein the unused thermoplastic resin material, the recycled thermoplastic resin material, and the pulverized and not-repelletized resin material prepared by pulverizing a molded product of a thermoplastic resin have identical compositions.

8. The molded product according to claim 5, wherein the thermoplastic resin material comprises polycarbonate and acrylonitrile-butadiene-styrene.

9. The molded product according to claim 5, wherein the thermoplastic resin material comprises polypropylene.
